(19) United States
(12) Patent Application Publication
(10) Pub. No.: US 2013/0159103 A1
(43) Pub. Date: Jun. 20, 2013

(54) Advertisement Selection Based on Mobile Applications

(71) Applicant: AppLovin Corporation, Palo Alto, CA (US)

(72) Inventors: Adam Foroughi, Menlo Park, CA (US); John Krystynak, Los Alto Hills, CA (US); Andrew Karam, Redwood City, CA (US); Furqan Rydhan, San Jose, CA (US); Matthew Bornski, Santa Clara, CA (US)

(73) Assignee: AppLovin Corporation, Palo Alto, CA (US)

(21) Appl. No.: 13/715,930

(22) Filed: Dec. 14, 2012

Related U.S. Application Data
(60) Provisional application No. 61/576,900, filed on Dec. 16, 2011.

(51) Int. Cl. G06Q 30/02

(52) U.S. Cl. CPC G06Q 30/0269
USPC 705/14.53; 705/14.66; 705/14.64

(57) ABSTRACT

Methods, systems, and computer-program products for selecting an advertisement message based on mobile applications installed on a mobile device are described. A list of mobile applications installed on the mobile device is received. At least one characteristic of the mobile applications on the list is analyzed to generate a user profile. An advertisement message may be selected based on the at least one characteristic of the mobile application and the user profile.

### RELATED APPLICATIONS

This application claims the benefit of U.S. Provisional Application No. 61/576,900 filed on Dec. 16, 2011 entitled “Advertisement Selection Based on Mobile Applications,” the entire disclosure of which is hereby incorporated by reference herein in its entirety.

### FIELD OF ART

The present disclosure relates to the selection and presentation of advertisement messages based on mobile platforms.

### BACKGROUND

The use of handheld devices has continued to increase. Handheld devices, such as laptops, mobile phones, smartphones, tablets, and personal digital assistants (PDAs) are popular amongst those who wish to use some of the powers of a conventional computer, in environments where carrying a computer might not be practical.

Mobile handheld devices are revolutionizing the way information can be disseminated. Mobile applications are being developed to be installed on these devices. The applications provide different functionalities and capabilities to the user of the mobile device. For example, applications may be installed on a mobile device to perform electronic mail functions, Internet browsing, geographical location detection, and the like. Some applications may be pre-installed on a mobile device during the manufacturing phase. Other mobile applications may be installed to the device after a consumer has purchased the device. For example, a user may purchase applications from a certain platform that offers the applications and then install the applications to the device.

Mobile devices may also provide or display advertisement messages to the user of the device. The messages may be advertisements for other mobile application, products, services, etc. Advertisement campaigns typically receive a greater rate of return from advertisements that have been specifically targeted to a certain user or group of users. For example, a user that receives an advertisement for a product may be more likely to purchase the product if the user is interested in the product. As a result, advertisement companies desire to learn information about potential customers and then provide advertisement messages to these potential customers that are targeted to their interests, preferences, etc. Targeted advertisement messages may result in greater sales of the product or service that is being advertised.

### BRIEF DESCRIPTION OF THE DRAWINGS

A further understanding of the nature of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an exemplary network environment;

FIG. 2 is a block diagram illustrating one example of a mobile device;

FIG. 3 is a block diagram illustrating one example of a server;

FIG. 4 shows a block diagram of an exemplary mobile device providing detection for the number of mobile applications, the classification of the applications, and the usage level of the applications installed on the mobile device;

FIG. 5 depicts a block diagram of a computer system, such as a server, suitable for implementing the present systems and methods;

FIG. 6 shows an exemplary method for selecting a targeted advertisement message to transmit to a mobile device;

FIG. 6 shows an exemplary aggregation architecture implemented on a user device; and

FIG. 7 shows an exemplary method for detecting mobile applications installed on a mobile device;

### DETAILED DESCRIPTION

The development of mobile applications has increased dramatically. Mobile applications may be software that is developed for small low-power handheld devices, such as mobile phones, smart phones, tablets, laptops, and personal digital assistants (or PDAs). These mobile applications may be pre-installed on mobile phones during manufacture, or downloaded by customers from various mobile software distribution platforms. For example, developers and vendors of mobile applications may publish their applications on application stores, such as the Apple App Store®, the Android Market®, etc. Consumers may visit these platforms to purchase and download mobile applications to install on their mobile phone.

The supply of advertisement messages to users of mobile phones has also increased. Ad networks have been established that connect advertisers to consumers using the mobile applications installed on mobile phones. One example of an ad network may include a targeted network. A targeted network may focus on specific targeting technologies such as behavioral or contextual. Targeted networks may specialize in using consumer data to enhance the value of the product or service being advertised to the consumer. Examples of consumer data may include past purchases by the consumer, browsing history of the consumer on the Internet, and the like. The present systems and methods may further enhance the targeted advertisement implementations by analyzing the types and quantity of mobile applications installed on the consumer's phone, as well as the level of usage of these applications to determine the specific advertisement messages to send to the consumer.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

### Configuration Overview

Methods, systems, and computer-program products for selecting an advertisement message based on mobile applications installed on a mobile device are described. In one example, a list of mobile applications that are installed on the mobile device is received. At least one characteristic of the mobile applications on the list may be analyzed. For example, the analyzed characteristics may include the type or classification of a mobile application, the usage level of the mobile application, etc. In one configuration, an advertisement message may be selected based on the at least one characteristic. The selected advertisement message may be transmitted to the mobile device and displayed to the user of the device.

Methods, systems, and computer-program products for detecting mobile applications installed on the mobile device are also described. In one example, memory or activity logs of the device may be scanned. Mobile applications installed on the mobile device may be detected based on the scan of the memory. A list of the applications that are installed on the device may be generated. The list may include information relating to each detected applications. For example, the list may include the title and other descriptive information about the applications. In one configuration, the list may also include information relating to the usage level of each application. For example, the list may include indicators that indicate how frequently a particular application is executed on the mobile device. In one embodiment, the generated list may be transmitted to a back-end server.

The foregoing has outlined rather broadly the features and technical aspects of examples according to disclosure. Additional features will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, will be better understood from the following description when considered in connection with the accompanying figures. Each of the figures is provided for the purpose of illustration and description only and not as a definition of the limits of the claims.

### Environmental Overview

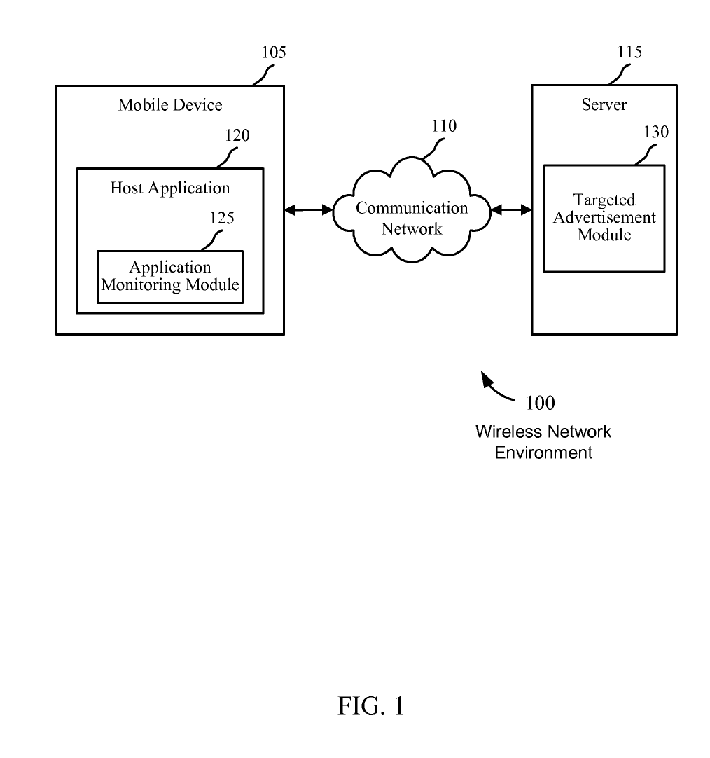

Referring now to FIG. 1, a block diagram illustrates an example of a wireless network environment 100. The network environment 100 may include a mobile device 105 and a server 115. The mobile device 105 may be, but is not limited to, a mobile cell phone, a Smartphone, a personal digital assistant (PDA), a tablet, and the like. The mobile device 105 and the server 115 may communicate via a communication network 110. In one embodiment, the mobile device 105 may include a host application 120. The host application 120 may be a mobile application installed on the mobile device 105 during the manufacturing of the mobile device 105, or the mobile application may be downloaded and installed to the mobile device 105 by the user.

The host application 120 may include an application monitoring module 125. The module 125 may monitor the mobile device 105 for certain information. For example, the monitoring module 125 may determine the quantity and type of mobile applications currently installed on the mobile device 105. In one configuration, the application monitoring module 125 may be a script that is embedded in the coding of the host application 120. When the host application 120 is launched or executed on the mobile device 105, the application monitoring module 125 may also be initiated. After the initiation, the module 125 may continue to execute after the execution of the host application is terminated. In another configuration, the module 125 may begin to execute when the host application 120 is installed on the device 105 instead of waiting until the host application 120 is executed.

The server 115 may include a targeted advertisement module 130. The module 130 may receive information from the application monitoring module 125 on the mobile device 105. In one embodiment, the targeted advertisement module 130 may analyze the received information and determine an advertisement message to transmit to the mobile device 105. The selected advertisement message may be an advertisement for a mobile application, a product, a service, etc. that may be specifically targeted to the user of the mobile device 105. The module 130 may determine the advertisement to send to the mobile device 105 based on the information received from the application monitoring module 125.

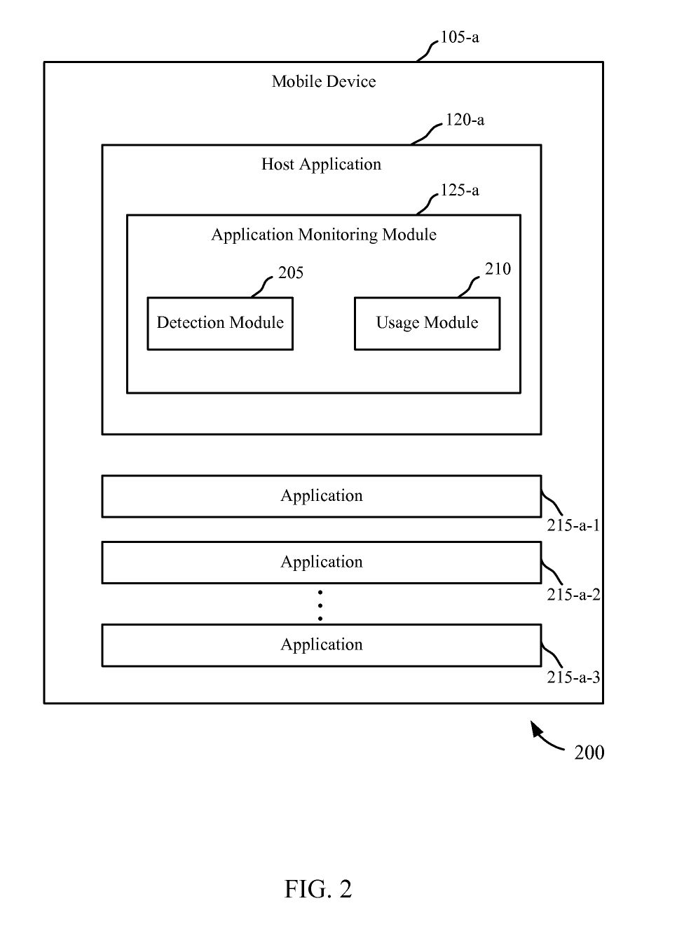

FIG. 2 is a block diagram illustrating one example of a mobile device 105-a. The mobile device 105-a may be an example of the mobile device 105 of FIG. 1. The mobile device 105-a may include a host application 120-a and a number of applications 215-a-1, 215-a-2, 215-a-3. For clarity, the applications will collectively be referred to as 215. The host application 120-a and the number of applications 215 may be mobile applications installed on the mobile device 105-a.

The host application 120-a may include an application monitoring module 125-a. The module 125-a may monitor the mobile device 105-a for certain information. For example, the application monitoring module 125-a may monitor the mobile device 105-a for information relating to mobile applications installed on the mobile device 105-a. In one configuration, the application monitoring module 125-a may include a detection module 205 and a usage module 210. The detection module 205 may scan the memory of the mobile device 105-a to determine the types and quantity of mobile applications installed on the mobile device 105-a. For example, the detection module 205 may scan the memory to detect files indicating the presence of a mobile application. The detection module 205 may analyze information about the detected applications to determine a category or type associated with the application. The detection module 205 may determine the category by analyzing the title of the application, keywords in the programming files of the application, and the like. Categories or types of applications may include, but are not limited to, gaming applications, financial applications, educational applications, social media applications, dating applications, entertainment applications, medical or health related applications, religious applications, and the like.

In one embodiment, the usage module 210 may detect how often a mobile application is used. For example, the usage module 210 may determine how frequently a particular mobile application is executed, launched, initiated, etc. The usage module 210 may also determine how long the applications remain in an active state after it has been initiated. In another embodiment, the usage module 210 may detect activity that occurs while the mobile application is active, including in-application purchases (also known as in-app purchases). As a result, the application monitoring module 125-a may determine the quantity of mobile applications 215 installed on the mobile device 105-a, the type or classification of each application 215 (e.g., game, educational, financial, etc.), as well as how often (and for how long) each application is activated.

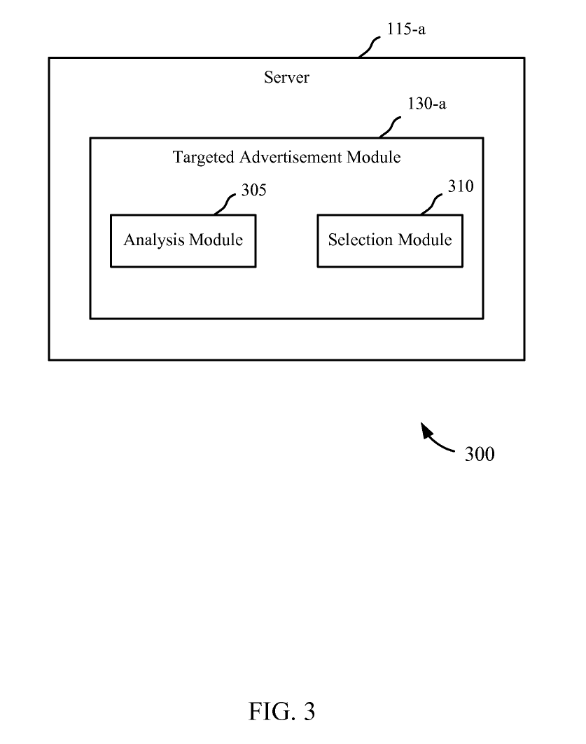

FIG. 3 is a block diagram illustrating one example of a server 115-a. The sever 115-a may be an example of the server 115 of FIG. 1. In one embodiment, the server 115-a may include a targeted advertisement module 130-a. The targeted advertisement module 130-a may determine which advertisement messages to send to a mobile device 105, based on certain attributes of the mobile device 105. In one configuration, the targeted advertisement module 130-a may include an analysis module 305 and a selection module 310. The analysis and selection modules 305 and 310 may determine the specific advertisement message to transmit to the mobile device 105.

In one example, the analysis module 305 may analyze information received from the mobile device 105. For example, the targeted advertisement module 130-a may receive information from the application monitoring module 125-a executing on the mobile device 105. The received information may include the number of mobile applications installed on the mobile device 105, the number of each type of mobile application, the usage frequency of each application, and the like. The analysis module 305 may analyze this received information to determine the overall quantity of mobile applications installed on the mobile device 105. The analysis module 305 may analyze applications and metrics from various application sources and types. The analysis module 305 may also analyze the information to ascertain the number of applications of a particular classification. For example, the analysis module 305 may determine that the mobile device 105 has twenty installed mobile applications. Out of these twenty applications, the analysis module 305 may determine that ten are dating applications, five are gaming applications, 3 are financial applications, and two are travel applications. The analysis module 305 may further analyze the information to determine how often each of these applications is launched or used and the length of time each application remains active after execution has been initialized.

In one embodiment, the information determined from the analysis module 305 may be communicated to the selection module 310. Based on the received information, the selection module 310 may select a particular advertisement message to transmit from the server 115-a to the mobile device 105. Following the above example, since 50% of the total number of mobile applications installed on the device 105 are dating applications, the selection module 310 may select an advertisement message that promotes another dating application that may interest the user of the mobile device 105. The advertisement message may further be a promotional message for a particular service or business relating to dating (e.g., restaurant, entertainment venues, flowers, etc.). As a result, the selection module 310 may select a targeted advertisement message for the user of the mobile device 105 based on, but not limited to, the number of applications installed on the device, the classification of each of these applications, and the usage level of the applications.

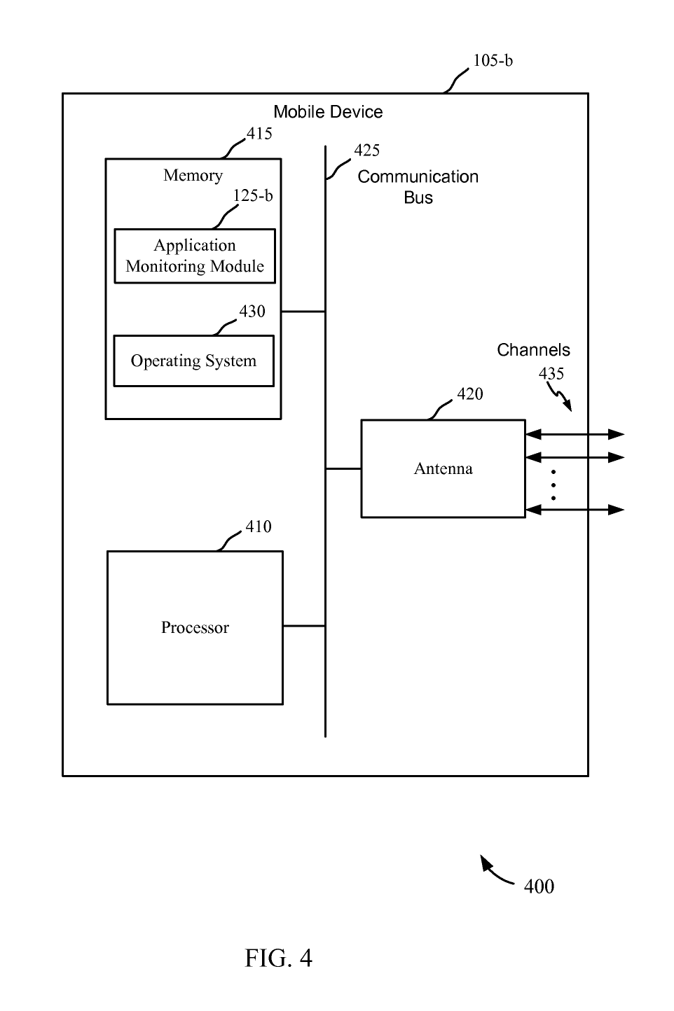

FIG. 4 shows a block diagram 400 of an exemplary mobile device 105-b providing detection for the number of mobile applications, the classification of the applications, and the usage level of the applications installed on the mobile device 105-b. The mobile device 105-b may be an example of the mobile device 105-a of FIG. 2, which may be an example of the device 105 of FIG. 1. The mobile device 105-b may include one or more processors 410, memory 415, and an antenna 420 all coupled to communicate using communication bus 425. The memory 415 may store an application monitoring module 125-b and an operating system 430. It should be noted that the device 105-b is just one implementation and that other implementations are possible.

In one aspect, processor 410 includes at least one of a central processing unit (CPU), processor, gate array, hardware logic, memory elements, and/or hardware executing software. The processor 410 operates to control the operation of the mobile device 105-b so that information relating to the mobile applications installed on the mobile device 105-b may be collected. In one implementation, the processor 410 may execute computer-readable instructions related to performing any of a number of functions. For example, the processor 410 may operate to analyze information received or communicated from the mobile device 105-b to determine information relating to the mobile applications installed on the mobile device 105-b. In another aspect, the processor 410 may operate to generate information that may be utilized by the memory 415 to determine attributes and other information relating to applications downloaded to the mobile device 105-b.

The antenna 420 may include hardware and/or a processor executing software that may provide a number of radios/interfaces that may be used to interface the device 105-b with a number of external entities, such as external communication networks using a number of channels 435. For instance, the antenna 420 may provide radios/interfaces to communicate using Cellular, WiFi, Bluetooth, or any other technologies to communicate with communication networks using the channels 435.

The memory 415 may include RAM, ROM, EEPROM or any other type of memory device that operates to allow information to be stored and retrieved at the device 105-b. In one implementation, the memory 415 may store computer-readable instructions executed by processor 410. Memory 415 may also store any of a number of other types of data including data generated by any of the processor 410, application monitoring module 125-b, and operating system 430. Memory 415 may include a number of different configurations, including as random access memory, battery-backed memory, hard disk, magnetic tape, etc. Various features can also be implemented upon memory 415, such as compression and automatic back up.

In various implementations, the device 105-b may include a computer program product having one or more program instructions (“instructions”) or sets of “codes” stored or embodied on a non-transitory computer-readable medium. When the codes are executed by at least one processor, for instance, processor 410, their execution causes the processor 410 to control the device 105-b to provide the functions of the mobile application detection architecture described herein. For example, the non-transitory computer-readable medium may be a floppy disk, CDROM, memory card, FLASH memory device, RAM, ROM, or any other type of memory device or computer-readable medium that interfaces to the device 105-b. In another aspect, the sets of codes may be downloaded into the device 105-b from an external device or communication network resource. The sets of codes, when executed, operate to provide aspects of the random delay architecture described herein.

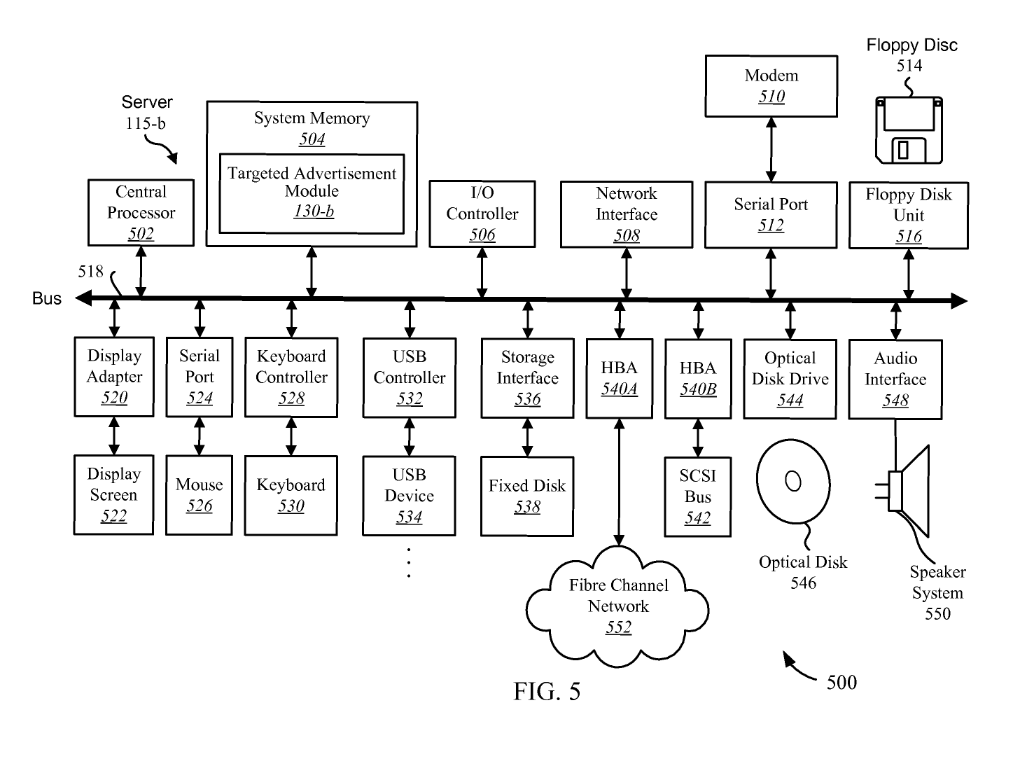

FIG. 5 depicts a block diagram of a computer system, such as a server 115-b, suitable for implementing the present systems and methods. The server 115-b may be an example of the server 115 of FIG. 1. The server 115-b may include bus 518 which interconnects major subsystems of the server 115-b, such as one or more central processors 502, a system memory 504 (typically RAM, but which may also include ROM, flash RAM, or the like), an input/output controller 506, an external audio device, such as a speaker system 550 via an audio output interface 548, an external device, such as a display screen 522 via display adapter 520, serial ports 512 and 524, a keyboard 530 (interfaced with a keyboard controller 528), multiple USB devices 534 (interfaced with a USB controller 532), a storage interface 536, a floppy disk unit 516 operative to receive a floppy disk 514, a host bus adapter (HBA) interface card 540A operative to connect with a Fibre Channel network 552, a host bus adapter (HBA) interface card 540B operative to connect to a SCSI bus 542, and an optical disk drive 544 operative to receive an optical disk 546. Also included are a mouse 526 (or other point-and-click device, coupled to bus 518 via serial port 524), a modem 510 (coupled to bus 518 via serial port 512), and a network interface 508 (coupled directly to bus 518).

Bus 518 allows data communication between central processor 502 and system memory 504, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. In one example, the targeted advertisement module 130-b may be stored within the system memory 504. Applications resident with the server 115-b may be stored on and accessed via a non-transitory computer readable medium, such as a hard disk drive (e.g., fixed disk 538), an optical drive (e.g., optical drive 544), a floppy disk unit 516, or other storage medium. Additionally, applications can be in the form of electronic signals modulated in accordance with the application and data communication technology when accessed via network modem 510 or interface 508.

Storage interface 536, as with the other storage interfaces of the server 115-b, may connect to a standard computer readable medium for storage and/or retrieval of information, such as a fixed disk drive 538. Fixed disk drive 538 may be a part of the server 115-b or may be separate and accessed through other interface systems. Modem 510 may provide a direct connection to a remote device, such as the mobile device 105, via a telephone link or to the Internet via an internet service provider (ISP). Network interface 508 may provide a direct connection to a remote device via a direct network link to the Internet via a POP (point of presence). Network interface 508 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 5 need not be present to practice the present systems and methods. The devices and subsystems can be interconnected in different ways from that shown in FIG. 5. The operation of a computer system such as that shown in FIG. 5 is readily known in the art and is not discussed in detail in this application. Code to implement the present system and methods may be stored in a non-transitory computer-readable medium such as one or more of system memory 504, fixed disk 538, optical disk 546, or floppy disk 514. The operating system provided on the server 115-b may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

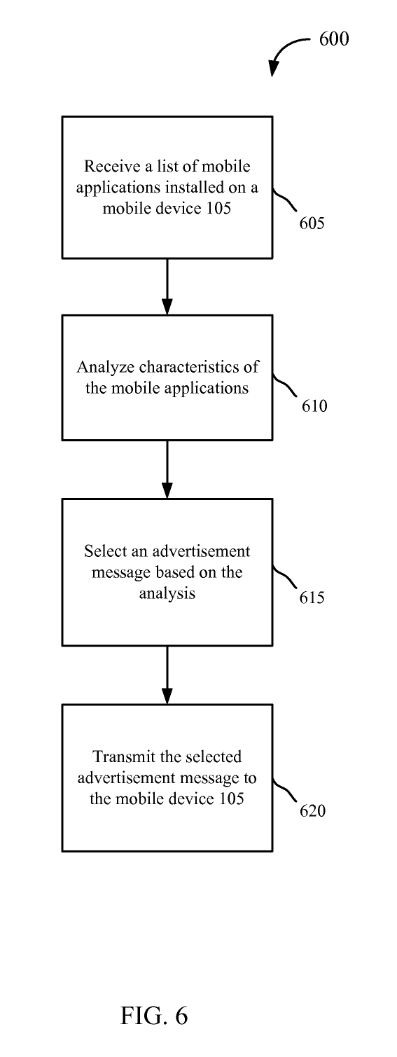

FIG. 6 shows an exemplary method 600 for selecting a targeted advertisement message to transmit to a mobile device 105. For clarity, the method 600 is described below with reference to the server 115-a and 115-b shown in FIGS. 2 and 5, which are examples of the server 115 shown in FIG. 1. In one implementation, the central processor 502 may execute one or more sets of codes to control targeted advertisement module 130 to perform the functions described below

At block 605, a list of mobile applications installed on the mobile device 105 is received. The list may be received from the mobile device 105. In one configuration, the list includes a title, description, version, image, etc. for each mobile application installed on the mobile device 105. The list may further include an indicator to indicate the usage level of each application. For example, the list may include a numerical indicator to indicate the number of times a particular application has been executed. The indicator may be a percent indicator that indicates the percentage a particular application has been launched compared to the other applications. The indicator may be a numerical rating that rates the applications in order of their respective usage levels. Additional types of indicators may be used to represent the level of use of a particular application on the list of mobile applications.

At block 610, characteristics of the mobile applications may be analyzed. For example, the information regarding the applications included on the list of mobile applications may be analyzed to determine the number of applications installed on the mobile device 105, the classification of each application (e.g., whether an application is a dating application, gaming application, travel application, educational application, etc.). The information may also be analyzed to determine which applications on the list are used more frequently, less frequently, etc. Based on the analysis of the applications installed on the mobile device 105, the server 115 may generate a profile for the user of the mobile device 105. The profile may provide information about the user's preferences, dislikes, hobbies, interests, etc. based on the number and type of applications the user has installed on the mobile device 105. The information in the profile may also be determined based on the types of applications used more frequently by the user. Additionally, the system may determine the user's propensity to click on served advertisements based on the user profile and past behavior. The user profile may be generated and stored within the analysis module 305 of the targeted advertisement module 130-a (shown in FIG. 3). For example, the analysis may reveal that a number of dating service applications are installed on the mobile device 105, which are executed regularly on the device 105. The profile may indicate that the user of the device 105 is single and is interested in dating. The analysis may also reveal that an entertainment application is also installed on the device 105 and is used frequently. The entertainment application may provide information about movies, restaurants, theaters, and the like. Based on this analysis, the profile may also indicate that the user has an interest in, for example, movies, and a propensity to click on a served advertisement related to that interest. The user's propensity to click and advertisement can be computed using a statistical model (e.g., a Bayesian statistical model) trained with historical click and user data to predict click rates.

At block 615, an advertisement message may be selected based on the analysis of the mobile applications installed on the device 105. For example, based on the example profile provided above, an advertisement message advertising another dating application may be selected. The message may be directed to a dating service or an event targeted for individuals that are single. As another example, the advertisement message may be directed to a particular movie, movie theater, another entertainment application, and the like. At block 620, the selected advertisement message may be transmitted to the mobile device 105 of FIG. 1, 2, or 4. As a result, the user of the mobile device 105 may receive one or more advertisement messages that are targeted to the user's interests, habits, preferences, etc. based on the types of mobile applications the user has installed on the device 105. Thus, the present systems and methods may enable ad networks to select advertisement messages that may be more effective for a particular user based on the applications installed on the user's mobile device. By modeling historical click rates as a function of the set of applications installed on the user's mobile device, a prediction of advertisement performance can be made for users with similar application sets. The model could be improved using machine learning techniques as more data is collected.

Therefore, the method 600 may select a targeted advertisement message to transmit to a mobile device 105. It should be noted that the method 600 is just one implementation and that the operations of the method 600 may be rearranged or otherwise modified such that other implementations are possible.

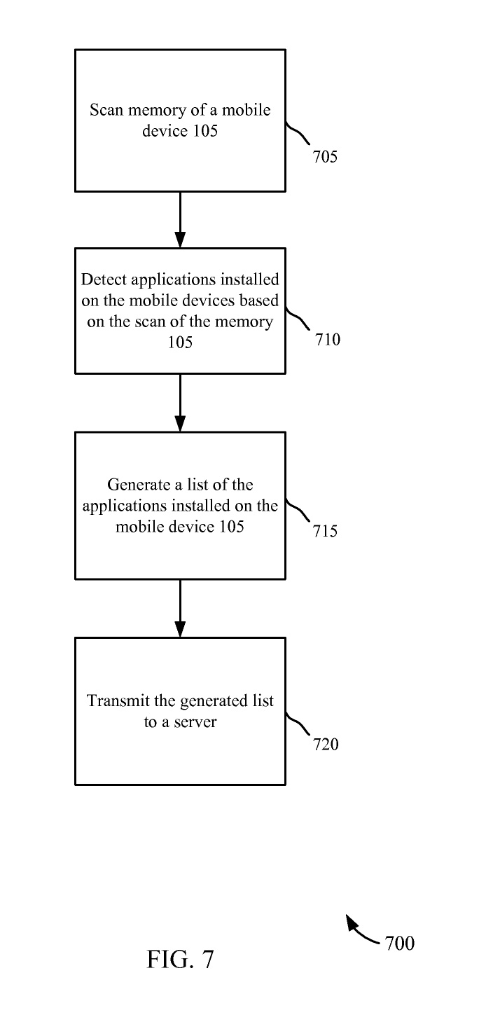

FIG. 7 shows an exemplary method 700 for detecting mobile applications installed on a mobile device 105. For clarity, the method 700 is described below with reference to the device 105-a and 105-b shown in FIGS. 2 and 4, which are examples of the device 105 shown in FIG. 1. In one implementation, the processor 410 may execute one or more sets of codes to control the application monitoring module 125 to perform the functions described below.

At block 705, the memory 415 of the mobile device 105 may be scanned. At block 710, mobile applications installed on the device 105 may be detected from the scan of the memory 415. For example, the application monitoring module 125 may scan the memory 415 for executable files representing a mobile application. The detection module 205 may detect the files associated with the mobile applications. In addition, the usage module 210 may determine how often each particular application has been executed or launched. The usage module 210 may evaluate time stamps indicating when a particular application was used. The usage module 210 may identify the level of use of each application detected by the detection module 205.

At block 715, a list of the mobile applications installed on the mobile device may be generated. The list may identify each application and indicate the respective usage level. At block 720, the generated list may be transmitted to a server, such as the server 115 of FIG. 1, 3, or 5.

Therefore, the method 700 may provide for detecting mobile application installed on the mobile device 105. It should be noted that the method 700 is just one implementation and that the operations of the method 700 may be rearranged or otherwise modified such that other implementations are possible.

Additional Considerations

The disclosed embodiments beneficially generate user profiles for users of mobile devices that improve the user experience within the mobile application and improve an advertiser's ability to directly target a consumer with a targeted advertisement. By generating user profiles that capture information related to user interests, preferences, demographics, and propensity to act on particular, served, targeted advertisements, the disclosed embodiments ensure users are only served advertisements that interest the user and ensure more efficient targeting of products or services. Because the embodiments capture systems that can be improved with machine learning techniques, the disclosed concepts will be even more efficient over time as more is learned about the mobile device user and the various product offerings.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a non-transitory computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the disclosed configuration. Various modifications to these exemplary embodiments will be readily apparent to those skilled in the art, and the generic principles defined herein may be applied to other embodiments without departing from the spirit or scope of the disclosed embodiments. Thus, the invention is not intended to be limited to the exemplary embodiments shown herein but is to be accorded the widest scope consistent with the principles and novel features disclosed herein.

1. A computer-implemented process to generate a user profile for a user of a mobile device, the method comprising:
receiving information related to the presence, identity, and usage of a mobile application installed on the mobile device;
analyzing a characteristic of the information related to the mobile application; and
generating a user profile for the user of the mobile device based on an analysis of information related to the presence, identity, and usage of the mobile application installed on the mobile device and the characteristic of the mobile application, the user profile comprising information on the demographics, preferences, interests, and propensity of the user to act on a served, targeted advertisement.

2. The process of claim 1, wherein the information related to the presence, identity, and usage of the mobile applications installed on the mobile device further comprises information related to an activity conducted by the user while the mobile application is active.

3. The process of claim 2, wherein the information related to the activity conducted by the user while the mobile application is active further comprises information related to in-application purchases.

4. The process of claim 1, wherein the information related to the presence, identity, and usage of the mobile applications installed on the mobile device further comprises information related to when the mobile application was installed.

5. The process of claim 1, wherein the information related to the presence, identity, and usage of the mobile applications installed on the mobile device further comprises information related to the frequency of use of the mobile application in relation to the frequency of use of any other mobile application installed on the mobile device.

6. The process of claim 1, wherein analyzing a characteristic of the information related to the mobile application further comprises classifying the mobile application.

7. The process of claim 1, wherein analyzing the information related to a characteristic of the mobile application further comprises determining the frequency and duration of activation of the mobile application.

8. The process of claim 1, wherein analyzing the information related to a characteristic of the mobile application further comprises determining which operating system platform and which version of the operating system the mobile application is utilizing.

9. The process of claim 1, wherein analyzing the information related to a characteristic of the mobile application further comprises determining a mobile carrier platform upon which the mobile application is installed.

10. The process of claim 1, wherein information related to the propensity of a user to act on a served, targeted advertisement further comprises history data corresponding to prior user action on a previously served, targeted advertisement.

11. The process of claim 1, wherein the information on the demographics, preferences, interests, and propensity of the user to act on a served, targeted advertisement is derived from the information related to the presence, identity, and usage of the mobile application on the mobile device of the user.

12. The process of claim 1, further comprising embedding in a host application a script to detect the applications installed on the mobile device.

13. The process of claim 1, further comprising:
selecting, based on the generated user profile, a targeted advertisement to be displayed on the mobile device of the user; and
serving the targeted advertisement to the mobile device.

14. The process of claim 1, further comprising storing the user profile.

15. A system for generation a user profile for a user of a mobile device, the system comprising:
a detection module configured to receive information related to the presence, identity, and usage of a mobile application installed on the mobile device;
an analysis module configured to analyze a characteristic of the information related to the mobile application; and
a targeted advertisement module configured to generate a user profile for the user of the mobile device based on an analysis of information related to the presence, identity, and usage of the mobile application installed on the mobile device and the characteristic of the mobile application, the user profile comprising information on the demographics, preferences, interests, and propensity of the user to act on a served, targeted advertisement.

16. The system of claim 15, wherein the information received by the detection module related to the presence, identity, and usage of the mobile applications installed on the mobile device further comprises information related to an activity conducted by the user while the mobile application is active.

17. The process of claim 16, wherein the information related to the activity conducted by the user while the mobile application is active further comprises information related to in-application purchases.

18. The system of claim 15, wherein the information received by the detection module related to the presence, identity, and usage of the mobile applications installed on the mobile device further comprises information related to when the mobile application was installed.

19. The system of claim 15, wherein the information received by the detection module related to the presence, identity, and usage of the mobile applications installed on the mobile device, further comprises information related to the frequency of use of the mobile application in relation to the frequency of use of any other mobile application installed on the mobile device.

20. The system of claim 15, wherein the analyzing of a characteristic of the information related to the mobile application conducted by the analysis module further comprises classifying the mobile application.

21. The system of claim 15, wherein the analyzing of a characteristic of the information related to the mobile application conducted by the analysis module further comprises determining the frequency and duration of activation of the mobile application.

22. The system of claim 15, wherein the analyzing of a characteristic of the information related to the mobile application conducted by the analysis module further comprises determining which operating system platform and which version of the operating system the mobile application is utilizing.

23. The system of claim 15, wherein the analyzing of a characteristic of the information related to the mobile application conducted by the analysis module further comprises determining a mobile carrier platform upon which the mobile application is installed.

24. The system of claim 15, wherein the information generated by the targeted advertisement module related to the propensity of a user to act on a served, targeted advertisement further comprises history data corresponding to prior user action on a previously served, targeted advertisement.

25. The system of claim 15, wherein the information generated by the targeted advertisement module related to the demographics, preferences, interests, and propensity of the user to act on a served, targeted advertisement is derived from the information received by the detection module related to the presence, identity, and usage of the mobile application on the mobile device of the user.

26. The system of claim 25, wherein the information received by the detection module further comprises information received from a script embedded in a host mobile application installed on the mobile device.

27. The system of claim 15, wherein the targeted advertisement module is further configured to:
select, based on the generated user profile, a targeted advertisement to be displayed on the mobile device of the user; and
serve the targeted advertisement to the mobile device.

28. The system of claim 15, further comprising a server to store the user profile.

29. A computer-readable storage medium configured to store instructions related to generation of a user profile for a user of a mobile device, the instructions, when executed by one or more processors, causing the processors to:
receive information related to the presence, identity, and usage of a mobile application installed on the mobile device;
analyze a characteristic of the information related to the mobile application; and
generate a user profile for the user of the mobile device based on an analysis of information related to the presence, identity, and usage of the mobile application installed on the mobile device and the characteristic of the mobile application, the user profile comprising information on the demographics, preferences, interests, and propensity of the user to act on a served, targeted advertisement.

30. The computer-readable storage medium of claim 29, wherein the received information related to the presence, identity, and usage of the mobile applications installed on the mobile device further comprises information related to an activity conducted by the user while the mobile application is active.

31. The computer-readable storage medium of claim 30, wherein the received information related to the activity conducted by the user while the mobile application is active further comprises information related to in-application purchases.

32. The computer-readable storage medium of claim 29, wherein the received information related to the presence, identity, and usage of the mobile applications installed on the mobile device further comprises information related to when the mobile application was installed.

33. The computer-readable storage medium of claim 29, wherein the received information related to the presence, identity, and usage of the mobile applications installed on the mobile device further comprises information related to the frequency of use of the mobile application in relation to the frequency of use of any other mobile application installed on the mobile device.

34. The computer-readable storage medium of claim 29, further comprising instructions that cause the processors to classify the mobile application when analyzing a characteristic of the information related to the mobile application.

35. The computer-readable storage medium of claim 29, further comprising instructions that cause the processors to determine the frequency and duration of activation of the mobile application when analyzing the information related to a characteristic of the mobile application.

36. The computer-readable storage medium of claim 29, further comprising instructions that cause the processors to determine which operating system platform and which version of the operating system the mobile application is utilizing when analyzing the information related to a characteristic of the mobile application.

37. The computer-readable storage medium of claim 29, further comprising instructions that cause the processors to determine a mobile carrier platform upon which the mobile application is installed when analyzing the information related to a characteristic of the mobile application.

38. The computer-readable storage medium of claim 29, wherein the information related to the propensity of a user to act on a served, targeted advertisement further comprises history data corresponding to prior user action on a previously served, targeted advertisement.

39. The computer-readable storage medium of claim 29, wherein the information on the demographics, preferences, interests, and propensity of the user to act on a served, targeted advertisement is derived from the information related to the presence, identity, and usage of the mobile application on the mobile device of the user.

40. The computer-readable storage medium of claim 39, wherein the information on the demographics, preferences, interests, and propensity of the user to act on a served, targeted advertisement further comprises information received from a script embedded in a host mobile application installed on the mobile device.

41. The computer-readable storage medium of claim 29, further comprising instructions that, when executed by one or more processors, cause the processors to:
select, based on the generated user profile, a targeted advertisement to be displayed on the mobile device of the user; and
serve the targeted advertisement to the mobile device.

42. The computer-readable storage medium of claim 41, further comprising instructions that, when executed by one or more processors, cause the processors to store the user profile.
